(19) United States
(12) Patent Application Publication
(10) Pub. No.: US 2026/0244439 A1
(43) Pub. Date: Aug. 20, 2026

(54) DYNAMIC LOG LEVEL MANAGEMENT

(71) Applicant: SAP SE, Walldorf (DE)

(72) Inventors: Madhusudan Sahu, Bangalore (IN); HARSHITH KUMAR REDDY BUSIREDDY, Bangalore (IN); Sumithra Sudharsanam, Bangalore (IN); Udith Sai Manda, Bangalore (IN)

(21) Appl. No.: 19/058,496

(22) Filed: Feb. 20, 2025

(51) Int. Cl. G06F 8/73

(52) U.S. Cl. CPC G06F 8/73

(57) ABSTRACT

Embodiments of the present disclosure include techniques for improving dynamic log level management. In one embodiment, a plurality of logging systems in a plurality of applications stores a plurality of log topics in a data storage system, each log topic having a first log level. Different log levels produce different amounts of information for log messages. A first logging system in a first application receives a first instruction to change the first log level of a first log topic to a second log level, having greater level of detail, changes the first log topic to the second log level in the application and the data storage system. The plurality of applications periodically detects modification of the first log topic data and change the first log level for the first log topic to the second log level in the plurality of applications excluding the first application.

### BACKGROUND

The present disclosure relates generally to computer software systems, and in particular, to dynamic log level management.

A log level management system is a software system that manages log topics within applications. A log level management system is used in cloud application development, allowing developers to control the granularity of log messages generated by their applications. In a cloud environment, developers can often adjust the log levels in the application by redeploying the application. This redeployment process can include hotfixing, a technique used to apply critical updates or fixed without taking the system offline. The redeployment process involves several processes, including pre-deployment checks, staging tests, and incremental rollouts. Redeploying an application to change the log level can be time consuming and burdensome and reduce the speed at which applications are developed.

The following disclosure provides various technical solutions to overcome the above stated problems.

### BRIEF DESCRIPTION OF THE DRAWINGS

FIG. 1 illustrates a dynamic log level management system according to an embodiment.

FIG. 2 illustrates a method for dynamic log level management according to an embodiment.

FIG. 3A illustrates an example implementation of the dynamic log level management system.

FIG. 3B illustrates an example UI according to an embodiment.

FIG. 3C illustrates an example process according to an embodiment.

FIG. 3D illustrates example log level changes according to an embodiment.

FIG. 3E illustrates example log level changes according to another embodiment.

FIG. 4A illustrates an example of a logging system flow for the dynamic log level management according to an embodiment.

FIG. 4B illustrates an example user flow for the dynamic log level management according to an embodiment.

FIG. 5 illustrates hardware of a special purpose computing system configured according to the above disclosure.

### DETAILED DESCRIPTION

Described herein are techniques for dynamic log level management. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

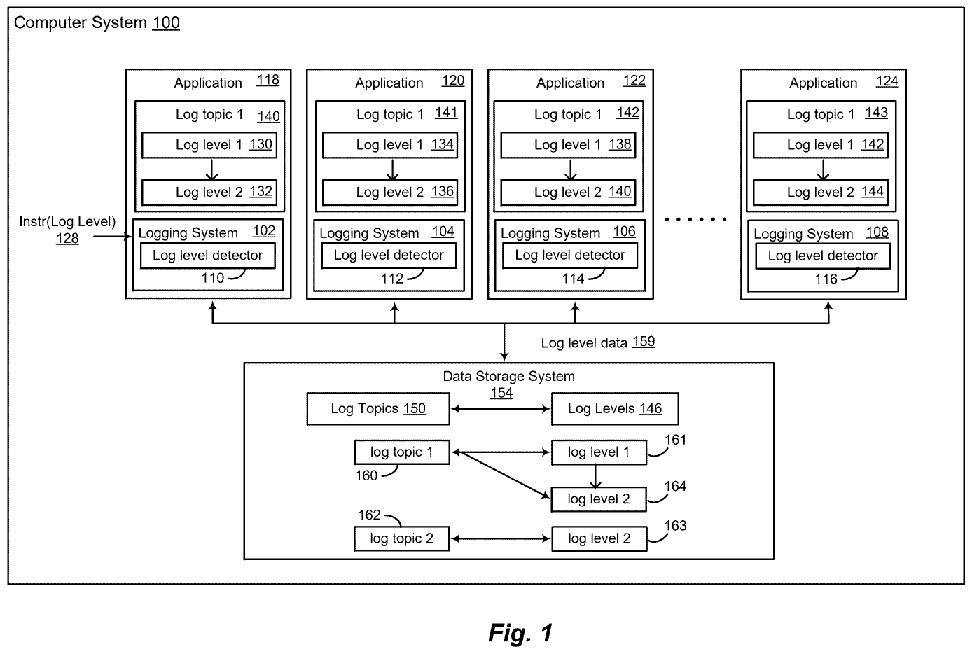

FIG. 1 illustrates a system for dynamic log level management according to an embodiment. Computer system 100 may include, for example, one or more computers comprising one or more processors and a computer readable medium (memory) for executing software to perform the techniques described herein. Here, embodiments of the present disclosure include techniques for dynamically adjusting log levels 130-144 for application 118-124 during runtime, for example. Features and advantages of the present disclosure include a plurality of logging systems 102, 104, 106, 108, each with a log detector 110, 112, 114, 116, used to coordinate log levels across a plurality of applications 118, 120, 122, 124. Logging systems 102, 104, 106, and 108 may be used across multiple applications 118, 120, 122, 124 with a data storage system 154 to synchronize log levels across the applications, for example. Initially, logging systems 102, 104, 106, and 108 in corresponding applications 118, 120, 122, 124 store data specifying log topics 150 in data storage system 154. Each log topic may be associated with a log level 146. For example, log topic 1 160 may have an associated log level 1 161 and log topic 2 may have an associated log level 2 163. As illustrated in examples below, different log levels may correspond to different types of information produced for log messages by the plurality of applications for each log topic. Logging systems 102, 104, 106, and 108 may be used to adjust the log level of a topic for an application, and the log level change is propagated to other applications through the data storage system 154. As illustrated here, data storage system 154 includes log topics 150 having associated log levels 146. For example, log topic 1 160 has an associated log level 1 161 and log topic 2 162 has an associated log level 2 163.

A logging system in one application may receive instructions that change the application log level for a topic and the topic's log level in data storage 154, and the changes are propagated to each other logging system to change the topic's log level in the other applications. For instance, logging system 102 in application 118 may receive an instruction 128 (e.g., from a user interface, not shown) to change log level 1 130 of log topic 1 140 to a log level 2 132 in the application 118, where log level 2 corresponds to a greater amount of information than log level 1, for example. Logging system 102 may change log level 1 130 for log topic 1 140 to log level 2 in application 118. Further, logging system 102 may modify data in the data storage system 154 corresponding to log topic 1 160 to be associated with log level 2 164 rather than log level 1 161. Logging systems 102, 104, 106, and 108 include log level detectors 110, 112, 114, and 116. Log level detectors 112, 114, and 116 may periodically detect modification of the data in data storage system 154 corresponding to log topic 1. Upon detection, each logging system 104, 106, and 108 changes log level 1 134, 138, and 142 for log topic 1 141, 142, and 143 to log level 2 136, 140, and 144 in applications 120, 122, and 124, respectively.

In one example embodiment, a process includes synchronizing the log levels during application startup, handling user-initiated log level changes, and periodically updating the application's log level based on data storage system entries, as described in more detail below. The first logging system 102, along with a set of logging systems 104, 106, 108 may be a same library of software services incorporated into each of the multiple applications 118, 120, 122, 124, for example.

In one example embodiment, during startup of each application, the log levels are synchronized. The logging systems 102, 104, 106, 108 retrieve all log topics from the data storage system 154 and compares the log topics with the log topics' initial application log levels 130, 134, 138, 142 in the applications 118, 120, 122, 124. The logging systems 102, 104, 106, 108 may identify any new or changed log topics, update the data storage system 154, and maintain a list of changes. After the comparison, the first logging system 102, along with the set of logging systems 104, 106, 108 for the multiple applications 118, 120, 122, 124, inserts and updates the log topics 150 in the data storage system 154 to ensure it remains in sync with the applications 118, 120, 122, 124. Each log topic 150 may be associated with a default log level (e.g., log level 1). As illustrated in examples below, each log topic may also be associated with a log topic identification (ID).

Different log levels may generate distinct types of log message information for each log topic. The log levels may form a sequence of increasingly detailed messages, for example. Thus, as a log level progresses from a lowest level to a highest level, the message detail may increase for a particular topic, and conversely, as the log level decreases from a highest level to a lowest level, the message detail may decrease for the particular topic. In some embodiments, users can increase the log level for a specified time period, but may not manually decrease the log level during this specified time period. In one embodiment, the log levels follow a lowest to highest progression from error, warn, info, debug, and trace, with error representing the lowest level of detail in the log messages, and trace representing the highest level of detail in the log messages.

The technique described herein allows users to adjust logging levels dynamically without interrupting the application's operation. This is particularly useful for debugging or troubleshooting issues in real-time without the need for downtime. As log levels can be updated during runtime, the applications do not need to be redeployed. With the ability to adjust the log level during runtime, users can increase the details of the log messages to gather more detailed logs for troubleshooting issues log level automatically reverts back to the original log level without affecting the application's availability. By changing log level dynamically, users can avoid generating excessive log data at a high level of details (e.g., at the trace log level), which might impact system performance or fill up storage. Lowering the log level when not needed helps manage storage and system resources efficiently. Eliminating redeployment of application can save time and resources, as there is no need to go through full application redeployment process which may involve manual steps, testing and potential errors.

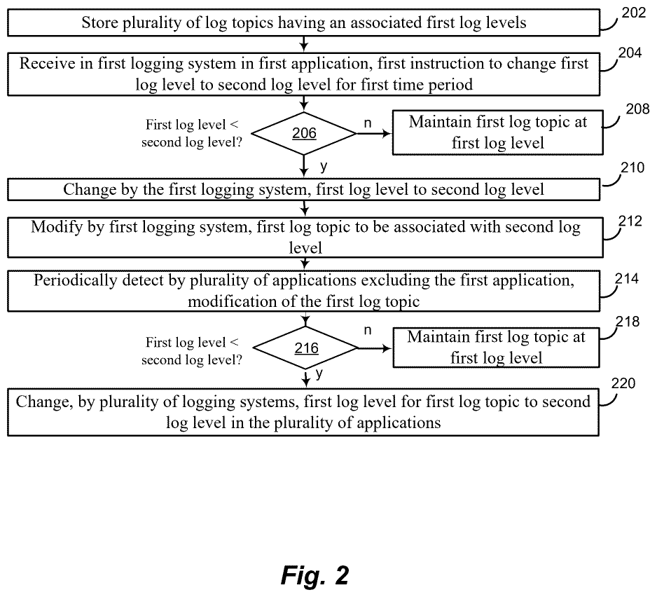

FIG. 2 illustrates a method for dynamic log level management according to an embodiment. At 202, a plurality of logging systems in a plurality of applications stores data specifying a plurality of log topics in a data storage system, each log topic having an associated first log level. Different log levels correspond to different information produced for log messages by the plurality of applications for each log topic. At 204, a first logging system in a first application of the plurality of applications, receives a first instruction to change the first log level of a first log topic to a second log level. The second log level corresponds to a greater level of detail than the first log level. In this example, when the first log level is not lower than the second log level at 206, the first logging system maintains the first log topic at the first log level at 208. However, when the first log level is lower than the second log level at 206, the first logging system changes the first log level for the first log topic to the second log level in the first application at 210. At 212, the first logging system in the first application modifies the data in the data storage system corresponding to the first log topic to be associated with the second log level. At 214, the plurality of applications excluding the first application, periodically detects the modification of the data corresponding to the first log topic. In this example, when the first log level is not lower than the second log level at 216, the plurality of applications in the remaining logging systems maintains the first log topic at the first log level at 218. However, when the first log level is lower than the second log level at 216, the plurality of logging systems excluding the first logging system, changes the first log level for the first log topic to the second log level in the plurality of applications at 220.

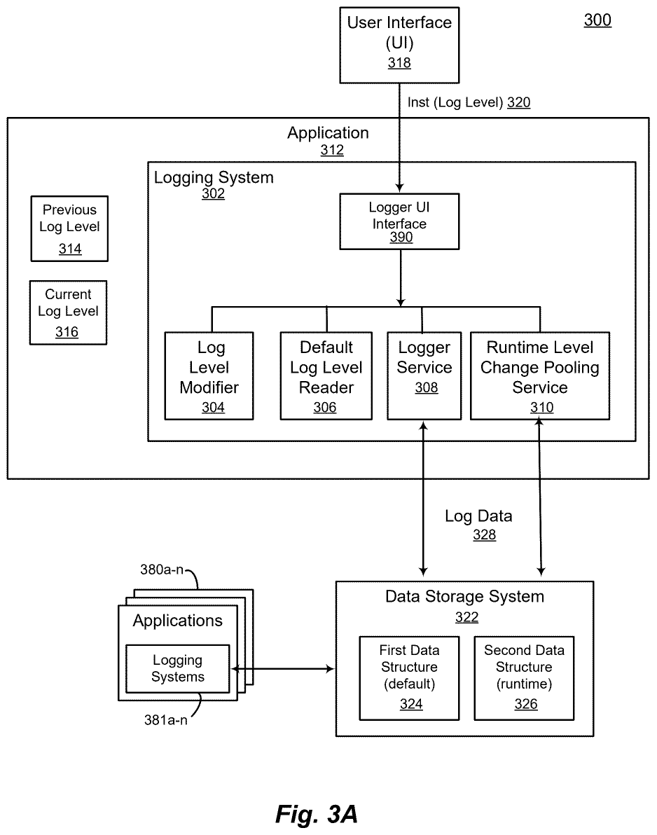

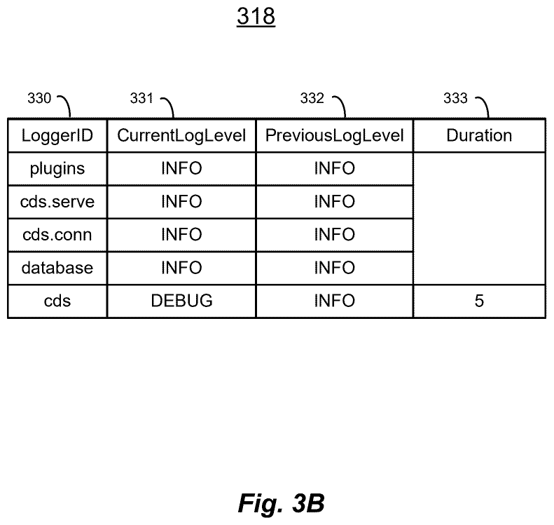

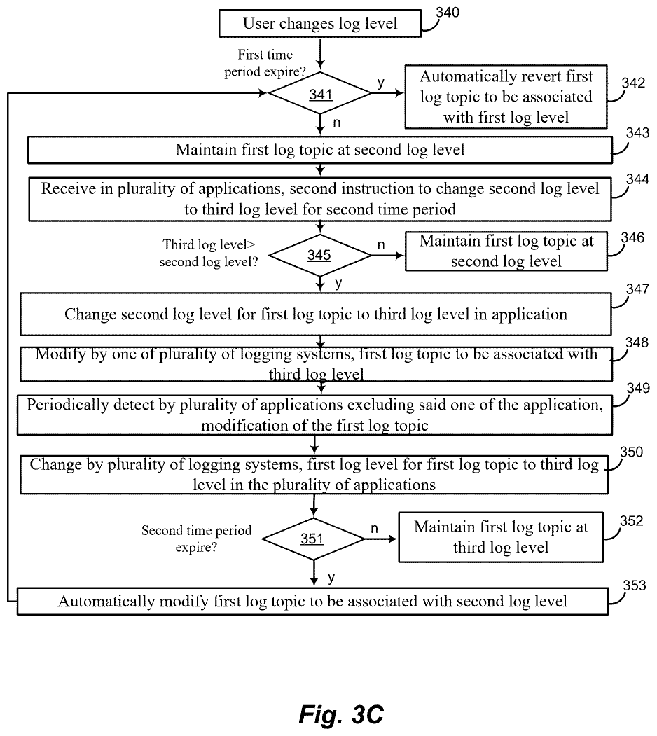

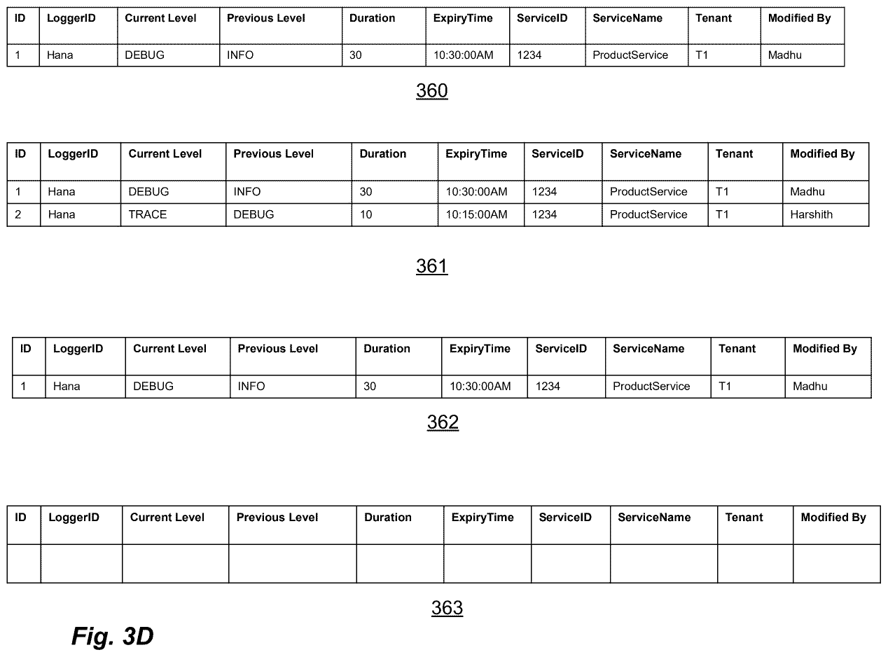

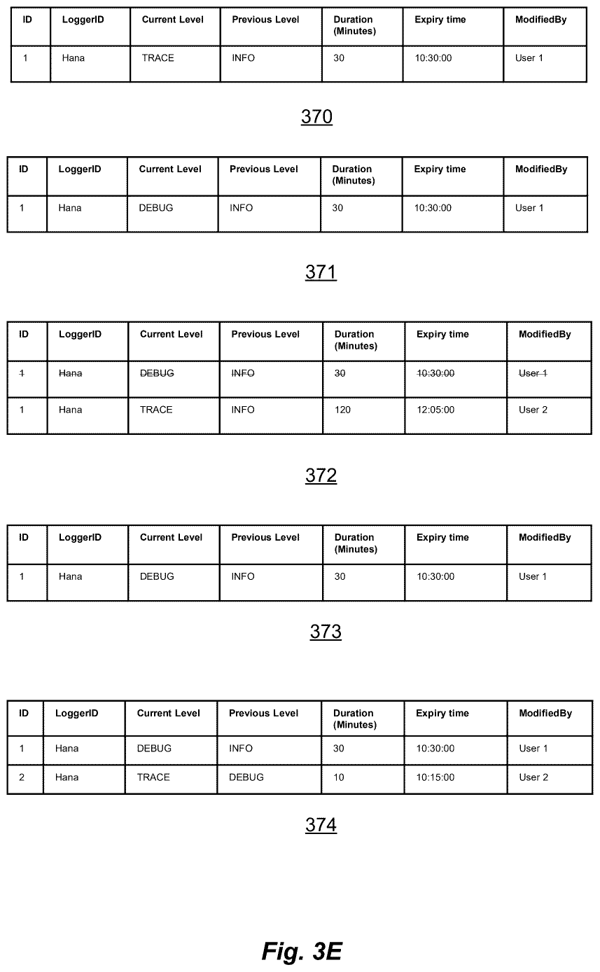

FIG. 3A illustrates an example implementation of the dynamic log level management system 300. An example logging system 302 includes a log level modifier 304, a default log level reader 306, a logger service 308, and a runtime level change pooling service 310. The logging system 302 is integrated with an application 312. For example, in some embodiments logging system 302 may be a same library of software services incorporated into each of a number of applications, such as application 312.

Log data 328 for the system is displayed through a user interface (UI) 318, where log topics and their log level details are displayed to users. UI 318 may be a browser, for example, driving by logger UI interface software 390 in logging system 302. FIG. 3B illustrates an example UI according to an embodiment. In this example, different log topics (aka, “loggers”) are presented in a table showing the log topic ID (loggerID) 330 and associated current log level 331 and a previous log level 332. In some embodiments, the UI 318 may include an ID for a particular application, service, or tenant, for example, in the case of more than one application, service, or tenant. As described further below, some embodiments may allow users to set a duration for a change in the log level for each log topic. In this example, loggerID “cds” has an associated current log level DEBUG, which is increased from previous log level INFO, for a duration of “5” (e.g., 5 minutes). In some embodiments, selecting one loggerID may enable a selection mechanism (e.g., a drop down window) to display selections for log levels (e.g., ERROR, WARN, INFO, DEBUG, TRACE) and durations (e.g., 1, 5, 10, 15, 30). Accordingly, UI 318 may allow a user to specify changes to log levels for each log topic and set a duration that the changed log level is in effect. As illustrated below, after the time period expires, some embodiments may automatically change the changed log level back to a default log level, for example. As described above, the user can increase the log level for a specified time period, but manual reduction of the log level may not be permitted. For example, the default level is ERROR for log topic 1 and INFO for log topic 2. User 1 is allowed to change log topic 1's log level to any level from WARN to TRACE, but the logging system 302 will not allow a manual reduction in log level. User 2 may only change log topic 2's log level to DEBUG or TRACE, as the logging system will revert to INFO after the specified time period. If a user tries to change log topic 2's log level to a value less than the default log level, the logging system 302 will return an error: “Lower log levels are not allowed.”

The following illustrates some example logs and log levels according to various embodiments. A log is a record of events, messages, or data generated by an application or system. Logs are often used for debugging, monitoring, auditing, and analysing the performance of applications. The following are example logs corresponding to two levels, WARN and INFO:
{“timestamp”:“2025-01-17T11:01:00Z”,“logger”:“product_service”,“level”:“WARN”,“message”:“Product unavailable”}
{“timestamp”:“2025-01-17T11:00:00Z”,“logger”:“product_service”,“level”:“INFO”,“message”:“User accessed product”}

Logs may include a timestamp, a log topic (aka logger, here, product_service), a level, and a message.

A logger is a software component used to create log messages. Loggers, which are referenced by log topics, allows developers to track the flow of execution and capture key events in a system. A database, “db,” may be the logger and is referenced by the log topic “db”. Loggers are configured to decide where and how the logs will be stored (console, file, database, etc.). Generally the system stores logs in the same place either in a console or file or database, but individual loggers can be configured to store logs in different places. The following illustrates logs generated by two different loggers, referred to by log topics (logger names) “product_service” and “inventory_service.”
{“timestamp”:“2025-01-17T11:01:00Z”,“logger”:“product_service”,“level”:“INFO”,“message”:“Product unavailable”}
{“timestamp”: “2025-01-17T11:00:00Z”,“logger”:“inventory_service”,“level”:“INFO”,“message”:“User accessed Inventory service”}

Here product_service and inventory_service are two loggers in an application, which has product and inventory functionality. Using these loggers we can either log the message or disable the logging for one or both of them. We can also control the storage.

As mentioned above, log levels are categories that define the importance or severity of a log message. Common log levels include, in order of increasing severity: ERROR (e.g., errors that prevent part of the application from working), WARN (e.g., indications of potential issues), INFO (e.g., general information about application flow), DEBUG (e.g., detailed information for developers), and TRACE (e.g., severe issues causing application failure).

As an example situation, product_service is a logger for product. If a user accesses the product service and is getting an error, then following record can be captured when the log level is set to INFO:
{“timestamp”: “2025-01-17 1200:00”, “logger”: “product_service”, “level”: “INFO”, “message”: “Fetching product details for product ID: 123”}
{“timestamp”: “2025-01-17 1200:01”, “logger”: “product_service”, “level”: “WARNING”, “message”: “Product stock is critically low for product ID: 456”}
{“timestamp”: “2025-01-17 1200:02”, “logger”: “product_service”, “level”: “ERROR”, “message”: “Failed to fetch product details due to a database timeout”}

In another example scenario, the logger product_service level is Debug, which generates the following:
{“timestamp”: “2025-01-17 1200:00”, “logger”: “product_service”, “level”: “INFO”, “message”: “Fetching product details for product ID: 123”}
{“timestamp”: “2025-01-17 1200:01”, “logger”: “product_service”, “level”: “WARNING”, “message”: “Product stock is critically low for product ID: 456”}
{“timestamp”: “2025-01-17 1201:01”, “logger”: “product_service”, “level”: “DEBUG”, “message”: “Executed SQL query: SELECT * FROM products WHERE id=123”}
{“timestamp”: “2025-01-17 1200:02”, “logger”: “product_service”, “level”: “ERROR”, “message”: “Failed to fetch product details due to a database timeout”}

In another example scenario, the logger product_service level is Trace, which generates the following:
{“timestamp”: “2025-01-17 1200:02”, “logger”: “product_service”, “level”: “TRACE”, “message”: “Entering on getProduct Method”}
{“timestamp”: “2025-01-17 1200:00”, “logger”: “product_service”, “level”: “INFO”, “message”: “Fetching product details for product ID: 123”}
{“timestamp”: “2025-01-17 1200:01”, “logger”: “product_service”, “level”: “WARNING”, “message”: “Product stock is critically low for product ID: 456”}
{“timestamp”: “2025-01-17 1200:02”, “logger”: “product_service”, “level”: “TRACE”, “message”: “Executing Database query to getProduct”}
{“timestamp”: “2025-01-17 1201:01”, “logger”: “product_service”, “level”: “DEBUG”, “message”: “Executed SQL query: SELECT * FROM products WHERE id=123”}
{“timestamp”: “2025-01-17 1200:02”, “logger”: “product_service”, “level”: “ERROR”, “message”: “Failed to fetch product details due to a database timeout”}
{“timestamp”: “2025-01-17 1200:02”, “logger”: “product_service”, “level”: “TRACE”, “message”: “Exception on getProduct method”}

From the above examples, it can be seen that different log levels generate different amounts of information. Further, in this example, increasing the log level appends additional information to information generated for a previous log level. However, it is to be understood that a wide variety of logs, log levels, and information generated for each log level may be used in various embodiments.

Referring again to FIG. 3A, logger service 308 performs reads and updates to data storage system 322 and the default and runtime data structures 324 and 326 stored therein. In the case of read operation, logger service 308 fetches the default log data from the default data structure 324 and also fetches the runtime log data from the runtime data structure 326, merges the data, and returns the response to logger UI interface 390. If duplicate data entries exist, then it may discard the default data entry during the merge, for example. As mentioned above, the UI 318 may be driven by logger UI interface 390, which may call logger service 308 to retrieve default log data and runtime log data, merge the data, and return the response to the logger UI interface 390. Logger UI interface 390, in turn, presents the data to UI 318 (e.g., in a browser).

Based on the above, a user can input changes to the log levels for different log topics in UI 318, and UI 318 may generate log level instructions 320 to the logging system 302 to change the log levels in application 312. Logging system 302 further stores log data 328 changes in a data storage system 322. In this example, the data storage system 322 includes a first data structure 324 and a second data structure 326. The first data structure 324 stores log topics and their corresponding default log levels. Accordingly, in some embodiments, all the default log levels for all the log topics across all applications may be stored in first data structure 324. The second data structure 326 stores log topics and corresponding changes to the log levels (e.g., when a user changes a log level from INFO to DEBUG).

Log levels for log topics in application 312 are modified by and retrieved by log level modifier 304 and default log level reader 306, respectively. For example, changes to log levels, received both locally via the logger UI interface 390 or remotely from data structure 326, are applied to application 312 by log level modifier 304. Default log level reader 306 may perform a number of functions. In some embodiments, default log level reader 306 is triggered during startup of the application 312. The default log level reader 306 creates first data structure 324 in data storage system 322 (e.g., a table) to store the default log level state of the log topics in each application, allowing the log topics to revert to their default log level state. In this example, the first data structure 324 maintains log details such as log topics (e.g., using loggerIDs) and the default log levels. In this example, default log level reader 306 reads default logger configurations for local application 312 and stores the configurations in the default logger data structure 324 using a tenant independent schema, for example. The following is one example table definition that may be used:

entity LoggerDefaults :cuid {
loggerID : String;
defaultLevel : String ;
serviceName : String;
serviceID : String;
}

The following Table 1 is an example default logger table with default logger configurations.

TABLE 1

| ID | LoggerID | DefaultLevel | ServiceName | ServiceID |
|---|---|---|---|---|
| 1 | Product | INFO | ProductService | 1234 |
| 2 | Inventory | INFO | InventoryService | 3456 |
| 3 | Database | WARN | ProductService | 1234 |

The above Table 1 illustrates that multiple application services are included in application 312 and the same logging system may be used for both services (e.g., ProductService and InventoryService). However, different services may utilize the logger system library separately, for example. Accordingly, a developer can set different configurations by default in code, for example, as shown on above example, where for Database in product service the default is the WARN level but for Inventory Service the default is the INFO level.

In this example, a second data structure 326, also known as the runtime log level data structure, is created to capture changes in the log topics' log levels from multiple applications. In some embodiments, a specified time or duration for each log level change as determined by the user. The second data structure 326 maintains log details such as log topics, log level, user, timestamp, and duration of the change. The following is an example table definition for data structure 326:

```
entity Log : cuid, managed {
  key loggerID : String;
  CurrentLevel : Association to one valueHelpLogLevels ;
  PreviousLevel : Association to one valueHelpLogLevels ;
  duration : Integer;
  logEndDate:Timestamp;
  tenantId : String;
}
```

An example runtime log level table is illustrated further below in FIG. 3D. Advantageously, the runtime log level data structure may include a current level and a previous level. Accordingly, and as illustrated in the example below, multiple users on different applications may change the log level for an associated duration. As each duration expires, the above data structure allows the system to revert to previous log levels. If a duration expires for the current level, the system may revert to the default level, for example.

The runtime level change pooling service 310 reads changes to the log data in data storage system 322 and updates the other applications. For example, a runtime level pooling service 310 in each logging system 302, 381a-n in each application 312, 380a-n may execute at a regular interval to check the second data structure 326 for any changes in log level entries. In some examples, the runtime level change pooling service 310 operates at a periodic (e.g., 10-second) interval, however any specified interval duration may be used (e.g., 5-second interval, 15-second interval, 20-second interval, etc.). The runtime level change pooling service 310 updates the application based on the entries in the default and runtime data structures. A variety of logical algorithms may be used to control how the updates are performed, which may use the duration mentioned above, for example, to control the log level for log topics in application 312, 380a-n.

As mentioned above, UI 318 allows users of different applications to update the log level. Users can change the log level from lower to higher (e.g., error→warn→info→debug→trace). In some embodiments, once a user has increased the log level, that log level cannot be reduced from higher to lower. Users can also specify the duration for which the log level will remain effective. When the user changes the log level, the request (e.g., instruction 320) is sent to the logger service 308 via a logger UI interface 390 in application 312. Logger service 308 updates a runtime entry for the topic in runtime table 326 and log level modifier 304 applies the new log level to application 312. Meanwhile, other applications will read the updated log level via their runtime level change pooling service, and the log level change for the log topic is thereby propagated to different applications. Prior techniques to log level changes typically changed the log level directly in the application's code each time, but this requires redeployment or repeated application restarts, which is burdensome and disadvantageous. The method disclosed herein takes a few seconds to apply the log level change across other applications, with a maximum delay of a few seconds (e.g., 10 seconds, etc.). This approach is also suitable for multitenant applications. Only authorized support users are permitted to change the log level.

FIG. 3C illustrates another aspect of the present disclosure. As mentioned above, a user may set a duration for changes of log levels for the log topics. At 340, a user changes a log level from a first log level to a second log level (e.g., from INFO to DEBUG) through application 312. In some example embodiments, the instruction 320 generated with the log level change further specifies a time period (e.g., corresponding to the duration field in the UI). After expiration of the time period at 341, the logging system 302 automatically deletes the second log level in the data storage system 322 corresponding to the log topic. The log level for the log topic reverts back to the first log level in application 312, at 342. Logging systems 381a-n (i.e., excluding logging system 312) periodically detect the reverted log level for the first log topic in the database and change the second log level for the first log topic back to the first log level in applications 380a-n (i.e., excluding application 312). In this example, when the time period has not expired at 341, logging systems 381a-n maintain the first log topic at the second log level in applications 380a-n, at 343.

In this example, at 344, one of the plurality of logging systems in one of the applications 312/380a-n, here application 380a, receives a second instruction to change the second log level of the first log topic to a third log level. The third log level may correspond to a greater level of detail than the second log level. When the third log level is not more than the second log level at 345, logging system 381a in application 380a maintains the first log topic at the second log level at 346. However, when the third log level is more than the second log level at 345, logging system 381a in application 380a changes the second log level for the first log topic to the third log level in application 380a at 347. At 348, logging system 381a modifies the data in the data storage system corresponding to the first log topic to be associated with the third log level. At 349, the other applications excluding application 380a, periodically detect the modification of the data corresponding to the first log topic. At 350, the other applications 312 and 380b-n change the second log level for the first log topic to the third log level.

In this example, the instruction to raise the log level to the third log level further specifies a second time period. After expiration of the second time period at 351, logging system 381a automatically modifies the data in the data storage system corresponding to the first log topic to be associated with the second log level, at 353. Logging system 381a further changes the third log level for the first log topic back to the second log level in application 380a. The other logging systems 302/381b-n (i.e., excluding logging system 381a) periodically detect and change the third log level for the first log topic to the second log level in the other applications. The process then returns to 341 where the log level for the first log topic reverts from the second log level to the first log level after expiration of the first time period.

FIG. 3D illustrates example log level changes according to an embodiment. In this example, at 10:00:00 AM a user changes a logger (e.g., hana) from INFO to DEBUG for ProductService. The runtime log level table (aka, RuntimeLoggerInfo table) is shown at 360, which includes the following fields: an ID (a row number), a log topic ID (loggerID), current level, previous level, duration, expiration time, service ID, service name, tenant, and an indication of which user modified the log level. Accordingly, the runtime polling service will create entry 360 with ID 1 in the table shown in 360. At 10:05:00 AM, another user changes the hana logger from DEBUG to TRACE for ProductService. Accordingly, the runtime polling service will create another entry on RuntimeLoggerInfo table as shown at 361 with ID 2. Advantageously, the system uses a first entry to capture the first log level change and a second entry to store the second log level change so that as the durations expire, the log level can revert from a current log level to the previous log level. As mentioned above, some embodiments may only allow increases to the log level. Thus, in this example, since both are for Hana logger and Trace is a higher log level than Debug, the system will enter a Trace log level for hana. Next, at 10:15:01 AM (after the 10 minute time period for Trace), the runtime polling service changes the hana logger from TRACE to DEBUG for the ProductService Application. Further, the entry for the ID 2 is deleted and the runtime table entry at 362 with ID 1 will be remaining. Finally, at 10:30:01 AM, the runtime polling service changes the hana logger from DEBUG to INFO for ProductService Application at the expiration of the 30 minute time period for Debug, deletes ID 1, and the RuntimeLoggerInfo table is now empty as illustrated at 363.

FIG. 3E illustrates example log level changes according to other embodiments. A first example scenario is when log levels are changed concurrently. For example, if User 1 changes the hana logger log level from INFO to TRACE at 10:00 AM and if User 2 changes the hana logger log level from INFO to DEBUG at 10:00 AM (e.g., at the same time), only one record will be persisted to the database since it is a concurrent scenario and one will get error message to try again due to concurrency.

A second example scenario is when a user attempts to change a log level to a lower log level. In this example, User1 changes the hana logger level from INFO to TRACE at 10:00 AM for 30 Minutes, as illustrated at 370, and User 2 changes the hana logger level from INFO to DEBUG at 10:05 AM for 1 Hours. Since User 1 has already changed to higher level (even though it is for lesser time) User 2 is not allowed to change logger level to lower level till the higher level entry is expired.

A third example scenario is when a second user exceeds the time of the first user. In this example, User1 changes the hana logger level from INFO to DEBUG at 10:00 AM for 30 Minutes (runtime table shown at 371), and User 2 changes the hana logger level from DEBUG to TRACE at 10:05 AM for 2 Hours (runtime table shown at 372). In this case, user 2 is changing to a higher logger level and its expiry time is also higher than User1, and therefore the previous record for User1 on the database is replace by User 2's Record but the previous level will be adapted from User1 as shown at 372. Accordingly, when the log level is successively increased and the time period of the subsequent log level change exceeds the time period of a preceding log level change, the previous level table field for the preceding log level change entry is copied into the previous level table field for the subsequent log level change and the preceding log level change entry is deleted.

In a fourth example scenario, a user enters a subsequent log level change for a shorter time than the preceding log level change. In this example, User 1 changes the hana logger level from INFO to DEBUG at 10:00 AM for 30 minutes so expiry as 10:30 AM as shown at 373, and User 2 changes the hana logger level from DEBUG to TRACE at 10:05 AM for 10 minutes so expiry as 10:15 AM as shown at 374. In this case, when User 2 changes to a higher logger level and its expiry time is also lower then User1, the previous record for User1 remains on the database and is becomes effective after expiry of log level change by User 2, at which point the table reverts back as shown in 373.

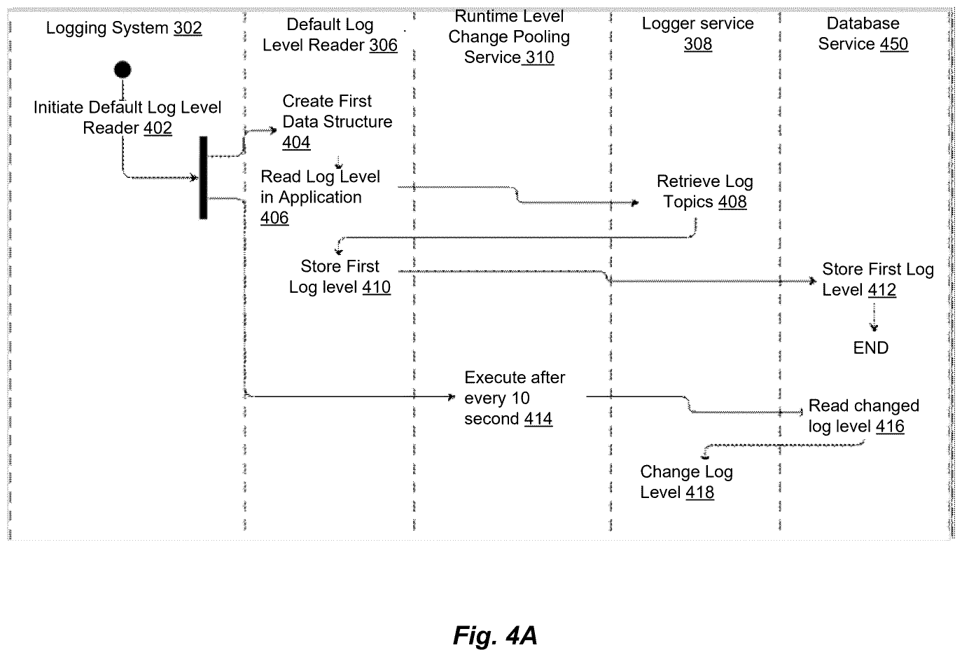

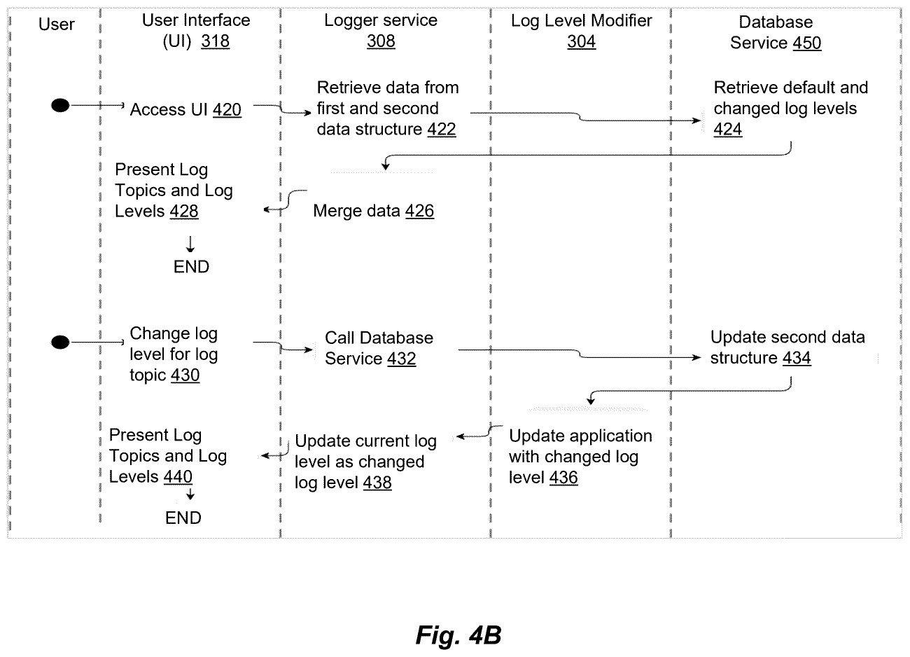

FIG. 4A illustrates an example system flow for dynamic log level management according to an embodiment. At 402, the logging system 302 initiates the default log level reader 306. At 404, the default log level reader 306 creates a first data structure 324 (e.g., for default log levels). At 406, the default log level reader 306 reads the log topics and corresponding default log levels from the application. At 408, the logger service 308 retrieves the log topics (e.g., loggers or loggerIDs). At 410, the default log level reader 306 stores the default log levels associated with the log topics. For example, the default log levels for each log topic loggerID for each service in the application may be stored in the default table 324 in data storage 322 as illustrated in Table 1 above, for example. At 412, the database service 450 stores the log topics with its corresponding default log level values in the first data structure 324 in the data storage system 322. At 414, the runtime level change pooling service 310 executes at a periodic interval (here, every 10 seconds) to check the data storage system 322 for changed log level. At 416, the database service 450 reads the changed log level from the second data structure 326 in the data storage system 322. At 418, the logger service 308 changes the log level in the application via the log level modifier 304.

FIG. 4B illustrates an example user flow for the dynamic log level management according to an embodiment. At 420, a user accesses the user interface 318. At 422, the logger service 308 retrieves log data from the first and second data structures, which represent the default and runtime data values for log topics and corresponding levels, respectively. At 424, the database service 450 retrieves the default log levels and changed log levels from the data storage system 322. At 426, the logger service 308 merges the default and changed log level data. For example, in some embodiments the logger service may compare new or changed loggers (log topics) and discard default log levels when duplicates are detected, for example. At 428, the UI 318 presents the log topics and corresponding log levels on the UI display. The UI may allow a user to change the log level for a log topic. At 430, the user changes the log level for a log topic. At 432, the logger service 308 calls the database service 450. At 434, the database service 450 updates the runtime log level data structure with the new log level for the log topic entered by the user. At 436, the log level modifier 304 updates the application with the changed log level. At 438, the logger service 308 updates the current log level with the changed log level in the merged log data set and sends it to the UI. At 440, the UI 318 presents the log topics and the corresponding log levels, including any changes, on the UI 318.

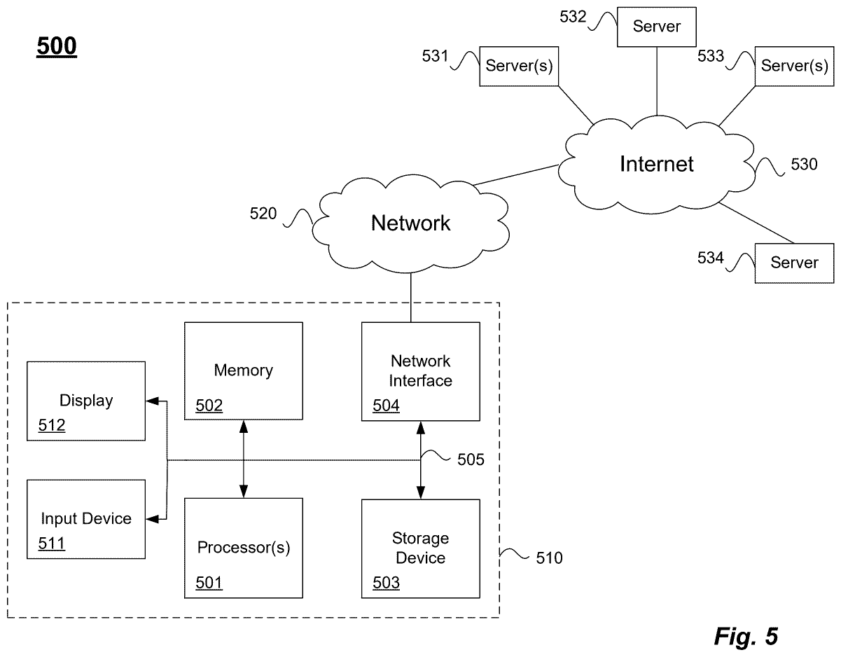

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a computer implemented method comprising: storing, by a plurality of logging systems in a plurality of applications, data specifying a plurality of log topics in a data storage system, each log topic having an associated first log level, wherein different log levels correspond to different types of information produced for log messages by the plurality of applications for each log topic; receiving, in a first logging system in a first application of the plurality of applications, a first instruction to change the first log level of a first log topic to a second log level, wherein the second log level corresponds to a greater level of detail than the first log level; changing, by the first logging system, the first log level for the first log topic to the second log level in the first application; modifying, by the first logging system in the first application, the data in the data storage system corresponding to the first log topic to be associated with the second log level; periodically detecting, by the plurality of applications excluding the first application, said modification of the data corresponding to the first log topic; and changing, by the plurality of logging systems excluding the first logging system, the first log level for the first log topic to the second log level in the plurality of applications excluding the first application.

In one embodiment, changing the first log level for the first log topic in the plurality of applications occurs without redeploying the plurality of applications.

In one embodiment, the plurality of logging systems is a same library of software services incorporated into each of the plurality of applications.

In one embodiment, the first instruction specifies a first time period, and wherein, after expiration of the first time period, the first logging system automatically modifies the data in the data storage system corresponding to the first log topic to be associated with the first log level and automatically changes the second log level for the first log topic back to the first log level in the first application, and wherein the plurality of logging systems excluding the first logging system periodically detect and change the second log level for the first log topic to the first log level in the plurality of applications excluding the first application.

In one embodiment, the first log level is a default log level.

In one embodiment, the method further comprises storing the default log level in a first data structure, the first data structure comprises a log topic identification (ID), and the associated default log level.

In one embodiment, the method further comprises receiving, in one of the plurality of logging systems in one of the plurality of applications, a second instruction to change the second log level of the first log topic to a third log level, wherein the third log level corresponds to a greater level of detail than the second log level; changing the second log level for the first log topic to the third log level in said one of the plurality of applications; modifying the data in the data storage system corresponding to the first log topic to be associated with the third log level; periodically detecting, by the plurality of applications excluding said one of the plurality of applications, said modification of the data corresponding to the first log topic; and changing, in the plurality of applications excluding said one of the plurality of applications, the second log level for the first log topic to the third log level.

In one embodiment, the second instruction specifies a second time period, and wherein, after expiration of both the second time period and the first time period, the first logging system automatically modifies the data in the data storage system corresponding to the first log topic to be associated with the first log level and automatically changes the third log level for the first log topic back to the first log level in the first application, and wherein the plurality of logging systems excluding the first logging system periodically detect and change the third log level for the first log topic to the first log level in the plurality of applications excluding the first application.

In one embodiment, the second instruction specifies a second time period, and wherein, after expiration of the second time period, and prior to the expiration of the first time period, the first logging system automatically modifies the data in the data storage system corresponding to the first log topic to be associated with the second log level and automatically changes the third log level for the first log topic back to the second log level in the first application, and wherein the plurality of logging systems excluding the first logging system periodically detect and change the third log level for the first log topic to the second log level in the plurality of applications excluding the first application.

In one embodiment, the method further comprises a plurality of user interfaces (UIs) displaying a plurality of log topics, each log topic associated with a current log level and a previous log level.

In one embodiment, the method further comprises storing the current log level and a previous log level in a second data structure, the second data structure comprises a log topic identification (ID), the current log level, and the previous log level.

In one embodiment, the method further comprises synchronizing the data storage system during startup.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method comprising:
storing, by a plurality of logging systems in a plurality of applications, data specifying a plurality of log topics in a data storage system, each log topic having an associated first log level, wherein different log levels correspond to different amounts of information produced for log messages by the plurality of applications for each log topic;
receiving, in a first logging system in a first application of the plurality of applications, a first instruction to change the first log level of a first log topic to a second log level, wherein the second log level corresponds to a greater level of detail than the first log level;
changing, by the first logging system, the first log level for the first log topic to the second log level in the first application;
modifying, by the first logging system in the first application, the data in the data storage system corresponding to the first log topic to be associated with the second log level;
periodically detecting, by the plurality of applications excluding the first application, said modification of the data corresponding to the first log topic; and
changing, by the plurality of logging systems excluding the first logging system, the first log level for the first log topic to the second log level in the plurality of applications excluding the first application.

2. The method of claim 1, wherein changing the first log level for the first log topic in the plurality of applications occurs without redeploying the plurality of applications.

3. The method of claim 1, wherein the plurality of logging systems is a same library of software services incorporated into each of the plurality of applications.

4. The method of claim 1, wherein the first instruction specifies a first time period, and wherein, after expiration of the first time period, the first logging system automatically modifies the data in the data storage system corresponding to the first log topic to be associated with the first log level and automatically changes the second log level for the first log topic back to the first log level in the first application, and wherein the plurality of logging systems excluding the first logging system periodically detect and change the second log level for the first log topic to the first log level in the plurality of applications excluding the first application.

5. The method of claim 1, wherein the first log level is a default log level.

6. The method of claim 5, further comprising storing the default log level in a first data structure, the first data structure comprising a log topic identification (ID), and the associated default log level.

7. The method of claim 1, further comprising:
receiving, in one of the plurality of logging systems in one of the plurality of applications, a second instruction to change the second log level of the first log topic to a third log level, wherein the third log level corresponds to a greater level of detail than the second log level;
changing the second log level for the first log topic to the third log level in said one of the plurality of applications;
modifying the data in the data storage system corresponding to the first log topic to be associated with the third log level;
periodically detecting, by the plurality of applications excluding said one of the plurality of applications, said modification of the data corresponding to the first log topic; and
changing, in the plurality of applications excluding said one of the plurality of applications, the second log level for the first log topic to the third log level.

8. The method of claim 7, wherein the second instruction specifies a second time period, and wherein, after expiration of both the second time period and the first time period, the first logging system automatically modifies the data in the data storage system corresponding to the first log topic to be associated with the first log level and automatically changes the third log level for the first log topic back to the first log level in the first application, and wherein the plurality of logging systems excluding the first logging system periodically detect and change the third log level for the first log topic to the first log level in the plurality of applications excluding the first application.

9. The method of claim 7, wherein the second instruction specifies a second time period, and wherein, after expiration of the second time period, and prior to the expiration of the first time period, the first logging system automatically modifies the data in the data storage system corresponding to the first log topic to be associated with the second log level and automatically changes the third log level for the first log topic back to the second log level in the first application, and wherein the plurality of logging systems excluding the first logging system periodically detect and change the third log level for the first log topic to the second log level in the plurality of applications excluding the first application.

10. The method of claim 1, further comprising a plurality of user interfaces (UIs) displaying a plurality of log topics, each log topic associated with a current log level and a previous log level.

11. The method of claim 10, further comprising storing the current log level and a previous log level in a second data structure, the second data structure comprises a log topic identification (ID), the current log level, and the previous log level.

12. The method of claim 1, further comprising synchronizing the data storage system during startup.

13. A computer system comprising:
storing, by a plurality of logging systems in a plurality of applications, data specifying a plurality of log topics in a data storage system, each log topic having an associated first log level, wherein different log levels correspond to different amounts of information produced for log messages by the plurality of applications for each log topic;
receiving, in a first logging system in a first application of the plurality of applications, a first instruction to change the first log level of a first log topic to a second log level, wherein the second log level corresponds to a greater level of detail than the first log level;
changing, by the first logging system, the first log level for the first log topic to the second log level in the first application;
modifying, by the first logging system in the first application, the data in the data storage system corresponding to the first log topic to be associated with the second log level;
periodically detecting, by the plurality of applications excluding the first application, said modification of the data corresponding to the first log topic; and
changing, by the plurality of logging systems excluding the first logging system, the first log level for the first log topic to the second log level in the plurality of applications excluding the first application.

14. The computer system of claim 13, wherein the first instruction specifies a first time period, and wherein, after expiration of the first time period, the first logging system automatically modifies the data in the data storage system corresponding to the first log topic to be associated with the first log level and automatically changes the second log level for the first log topic back to the first log level in the first application, and wherein the plurality of logging systems excluding the first logging system periodically detect and change the second log level for the first log topic to the first log level in the plurality of applications excluding the first application.

15. The computer system of claim 13, further comprising:
receiving, in one of the plurality of logging systems in one of the plurality of applications, a second instruction to change the second log level of the first log topic to a third log level, wherein the third log level corresponds to a greater level of detail than the second log level;
changing the second log level for the first log topic to the third log level in said one of the plurality of applications;
modifying the data in the data storage system corresponding to the first log topic to be associated with the third log level;
periodically detecting, by the plurality of applications excluding said one of the plurality of applications, said modification of the data corresponding to the first log topic; and
changing, in the plurality of applications excluding said one of the plurality of applications, the second log level for the first log topic to the third log level.

16. The computer system of claim 15, wherein the second instruction specifies a second time period, and wherein, after expiration of both the second time period and the first time period, the first logging system automatically modifies the data in the data storage system corresponding to the first log topic to be associated with the first log level and automatically changes the third log level for the first log topic back to the first log level in the first application, and wherein the plurality of logging systems excluding the first logging system periodically detect and change the third log level for the first log topic to the first log level in the plurality of applications excluding the first application.

17. The computer system of claim 15, wherein the second instruction specifies a second time period, and wherein, after expiration of the second time period, and prior to the expiration of the first time period, the first logging system automatically modifies the data in the data storage system corresponding to the first log topic to be associated with the second log level and automatically changes the third log level for the first log topic back to the second log level in the first application, and wherein the plurality of logging systems excluding the first logging system periodically detect and change the third log level for the first log topic to the second log level in the plurality of applications excluding the first application.

18. A non-transitory computer-readable medium storing computer-executable instructions that, when executed by at least one processor of a computer system, cause the computer system to execute method comprising:
storing, by a plurality of logging systems in a plurality of applications, data specifying a plurality of log topics in a data storage system, each log topic having an associated first log level, wherein different log levels correspond to different amounts of information produced for log messages by the plurality of applications for each log topic;
receiving, in a first logging system in a first application of the plurality of applications, a first instruction to change the first log level of a first log topic to a second log level, wherein the second log level corresponds to a greater level of detail than the first log level;
changing, by the first logging system, the first log level for the first log topic to the second log level in the first application;
modifying, by the first logging system in the first application, the data in the data storage system corresponding to the first log topic to be associated with the second log level;
periodically detecting, by the plurality of applications excluding the first application, said modification of the data corresponding to the first log topic; and
changing, by the plurality of logging systems excluding the first logging system, the first log level for the first log topic to the second log level in the plurality of applications excluding the first application.

19. The non-transitory computer-readable medium of claim 18, wherein the first instruction specifies a first time period, and wherein, after expiration of the first time period, the first logging system automatically modifies the data in the data storage system corresponding to the first log topic to be associated with the first log level and automatically changes the second log level for the first log topic back to the first log level in the first application, and wherein the plurality of logging systems excluding the first logging system periodically detect and change the second log level for the first log topic to the first log level in the plurality of applications excluding the first application.

20. The non-transitory computer-readable medium of claim 18, further comprising:
receiving, in one of the plurality of logging systems in one of the plurality of applications, a second instruction to change the second log level of the first log topic to a third log level, wherein the third log level corresponds to a greater level of detail than the second log level;
changing the second log level for the first log topic to the third log level in said one of the plurality of applications;
modifying the data in the data storage system corresponding to the first log topic to be associated with the third log level;
periodically detecting, by the plurality of applications excluding said one of the plurality of applications, said modification of the data corresponding to the first log topic; and
changing, in the plurality of applications excluding said one of the plurality of applications, the second log level for the first log topic to the third log level.
